(19) United States
(12) Patent Application Publication
(10) Pub. No.: US 2004/0166260 A1
(43) Pub. Date: Aug. 26, 2004

(54) Method of and arrangement for manufacturing printed objects such as foil balloons

(76) Inventor: Charles Phillips, White Plains, NY (US)

Correspondence Address: Kirschstein, Ottinger, Israel & Schiffmiller, P.C., 489 Fifth Avenue, New York, NY, 10017-6105, US

(21) Appl. No.: 10/782,442

(22) Filed: Feb. 19, 2004

Related U.S. Application Data
(60) Provisional application No. 60/448,857, filed on Feb. 21, 2003.

(51) Int. Cl. F16L 1/024

(52) U.S. Cl. 428/34.3; 428/35.7; 137/15.08

(57) ABSTRACT

An object, such as a foil balloon, is formed directly on a carrier and is manufactured while remaining on the carrier during subsequent heat sealing, die cutting, scrap removal, sheeting and printing operations.

### CROSS REFERENCE TO RELATED APPLICATION

This application claims the priority of U.S. Provisional Patent Application No. 60/448,857, filed Feb. 21, 2003.

### BACKGROUND OF THE INVENTION

1. Field of the Invention

This invention generally relates to manufacturing objects, especially inflatable objects, particularly foil balloons and, more particularly, to their manufacture with customized, unblemished designs, especially by printing the designs on the objects using sheet-fed printers.

2. Description of the Related Art

Non-latex balloons, often referred to as metallized film or foil balloons of the type exemplified by U.S. Pat. No. 4,077,588, are manufactured and printed with colorful generic designs, such as characters, messages or combinations thereof, typically by using flexography, offset-printing or rotogravure techniques at the time of manufacturing the foil. A retailer needs to stock each design to serve the varied desires of its customers. Even then, a specific, customized greeting or image, including a photograph, is not available.

Attempts have been made to use a photocopier to copy a custom design on the foil. However, the foil generally stretches and distorts when subjected to the high temperatures normally encountered in a copier. Also known is the attempt to use inkjet or bubblejet printers to print a custom design on the foil. However, the ink does not permanently dry on the foil, especially on a glossy surface thereof, and tends to smear as the foil is fed through the printer and, even thereafter, to smudge upon being touched.

It is known, for example, from International Publication No. WO 00/11067, now U.S. Pat. No. 6,663,455, to coat the glossy surface of the foil with an absorbent coating for absorbing the ink, thereby tending to alleviate the smudging problem. However, experience has shown that even when the foil is pre-coated with an absorbent coating, the freshly applied ink smears as the foil passes through the printer, primarily because the foil tends to move and wrinkle during passage through the printer.

To counter the wrinkling problem, said International Publication teaches that an uninflated foil balloon, after being formed, may be wrapped around a rigid substrate, such as a rectangular sheet, and fed as an assembly through the printer. However, the foil balloon consists of an upper sheet of thin gauge on which the design is to be printed, and a lower sheet held onto the substrate. The upper sheet is unsecured except at its periphery. During passage through the printer, the rollers engage the thin gauge upper sheet and tend to stretch and move the upper sheet relative to the lower sheet, thereby causing the wrinkling problem described above, and a concomitant blemished printed design.

Moreover, the wrapping of the uninflated foil balloon around the substrate as disclosed in said International Publication is not uniform, even when the lower sheet is adhered to the substrate. The thin gauge of the lower sheet tends to form air bubbles between itself and the substrate and, even when a smoothing pressure is wipingly applied across the balloon to compress the air bubbles, the foil sheets tend to stretch and deform, again leading to a blemished, printed design.

U.S. patent application publication No. 2003/0103219 A1 also teaches the mounting of an uninflated foil balloon, after being formed, on a frame, and the feeding of the balloon and the frame together through a sheet-fed printer. However, as before, the balloon tends, in printing, to move relative to the frame, and the thin gauge balloon surfaces tend to wrinkle along the feed path of the printer.

Other patents relating to balloon manufacture of which I am aware are U.S. Pat. No. 5,951,359 which teaches the printing of an image on an adhesive label for subsequent application to an uninflated foil balloon, U.S. Pat. No. 6,638,586 which teaches the attachment of one layer of film to a soft pad layer to be fed through a printer, and U.S. Pat. No. 6,632,120 which teaches heat tacking an object to one side of a balloon without heat tacking to an opposite side of the balloon. Also, U.S. patent application publication No. 2002/0178940 teaches the printing of an image on a transfer sheet and the subsequent transfer of the image to a balloon.

### SUMMARY OF THE INVENTION

### OBJECT OF THE INVENTION

Accordingly, it is an object of this invention to print a customized, unblemished design on an object such as a foil balloon using a conventional printer.

Another object of this invention is to develop a commercially viable production process to enable automated production of objects such as foil balloons in a form that allows them to be fed directly through a sheet-fed inkjet printer.

Still another object of this invention is to maintain a fixed, correct positional relationship between an object and a carrier for the object during manufacture of and printing on the object.

### FEATURES OF THE INVENTION

In keeping with these objects, and others which will become apparent hereinafter, one feature of this invention resides, briefly stated, in a method of manufacturing an object such as a non-latex or foil-type balloon, comprising the steps of forming a support carrier of a shape-retaining material; positioning a lower film of a flexible material more flexible than that of the carrier on and in overlapping relationship with the carrier; positioning an upper film of a flexible material more flexible than that of the carrier on and in overlapping relationship with the lower film; and sealing overlapping portions of the films together to form a sealed film assembly while the films are positioned on the carrier.

In accordance with this invention, a correct positional relationship is maintained between the sealed film assembly and the carrier. This can be accomplished in several ways. For example, the lower film may be adhered to the carrier, preferably simultaneously while the sealing step is performed. Thus, a heat-set adhesive is applied between the lower film and the carrier and, during the sealing step, the adhesive is activated to adhere the lower film to the carrier at the overlapping sealed portions. The heat-set adhesive may be pre-applied to either or both the lower film and the carrier. As another example, the lower film may be laminated to the carrier prior to performing the sealing step. Also, a repositionable adhesive may be applied between the lower film and the carrier to tack the lower film in place. In a modification, another repositionable adhesive may be applied between the films.

After sealing, the overlapping sealed portions may be cut or scored into the shape of the object while the films are positioned on the carrier. The carrier itself may be cut through in register with the sealed film assembly to form a sheet on which the sealed film assembly is supported. The sheet with the sealed film assembly supported thereon may be fed into a printer, typically an inkjet/bubblejet printer, controlled by a computer with a graphics software program for the printing of an individual, personalized design on the object. The design can be captured by a digital or video camera, a scanner, e-mail, clip art, or can be software-generated and created by a user at home, or can be downloaded from online resources, or combinations thereof. The design created at home, for example, can be transmitted electronically to a florist or like retailer for printing on a blank sealed film assembly at the retailer for subsequent delivery. In some cases, part of the design can even be preprinted.

The printed design is unblemished, wrinkle-free, and correctly registered on the object for several reasons. Foremost is that the object itself is made on the carrier, rather than being formed elsewhere and subsequently wrapped around or mounted on the carrier. The lower film is adhered to the carrier to prevent the assembly from moving relative to the carrier. Moving can occur during any one or all subsequent object manufacturing steps. The lower film may be adhered by the heat-set adhesive activated solely at the sealed overlapping portions, or by a repositionable adhesive or like tacky coating or surface, including static friction, located between the entire surface area of the lower film which contacts the carrier, and/or by another repositionable adhesive or like tacky coating or surface, including static friction, located between the entire surface areas of the lower and upper films which face each other. Preferably, the repositionable adhesive is applied on the carrier. During printing, neither film moves relative to each other, or relative to the carrier.

In the preferred embodiment, the object is a balloon, and the balloon is inflated by admitting a gas between the films at an inlet or nozzle, preferably one having a valve therein. As the gas is admitted, the adhesion or static friction between the films is overcome, and the films separate.

The forming, sealing and cutting of the films on the carrier offers several benefits. It is conventional to form, seal and cut films used for making a balloon not on a carrier, but on a silicone conveyor belt from which the resulting uninflated formed balloons are removed. Printing on such individual uninflated balloons is not practical, because the balloons cannot be fed through a printer without misfeeds or roller wraparounds due primarily to the thin gauge and stretchability of the films and their lack of support during passage through the printer. The carrier of this invention provides the necessary stiffness to enable such subsequent printing.

Moreover, the carrier provides a convenient means of registering a subsequent design on a designated area of one or both films as dictated by a software template controlled by a computer program. By forming the balloon on the carrier, and by preventing the films from moving, the exact position of the designated area is known at all times with respect to the border of the carrier.

It is desirable that the upper film be precoated with an ink absorbing flood coating or undercoat prior to its adherence to the lower film. It is further desirable that a further coating or topcoat be applied over the printed design to protect it.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a diagrammatic view of an arrangement for making an object in accordance with the method of this invention;

FIG. 2 is a top plan view of a balloon on a substrate during manufacture;

FIG. 3 is an enlarged, sectional view taken on line 3-3 of FIG. 2;

FIG. 4 is a diagrammatic view depicting a printing step of manufacture;

FIG. 5 is a view on a reduced scale of an inflated balloon made according to this invention; and

FIG. 6 is a top plan view of a modified balloon removed from a carrier.

### DETAILED DESCRIPTION OF THE PREFERRED EMBODIMENTS

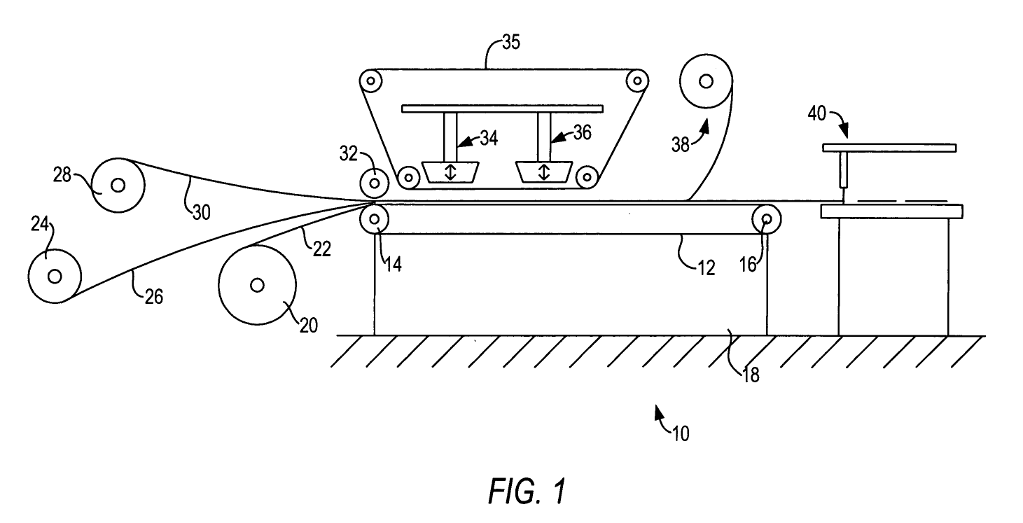

Referring to FIG. 1 of the drawings, reference numeral 10 generally identifies an arrangement for manufacturing objects in accordance with the method of this invention. The objects are, in the preferred embodiment, foil balloons, but could be any object, inflatable or not. For example, non-inflatable objects could be loot bags or hand puppets, whereas other inflatable objects could be bat-shaped noisemakers. What all these objects have in common is that they are formed from sheets of film that are at least partially sealed together, preferably with heat, and that printing is performed on at least one of the surfaces of one of the films. In the case of a balloon, the printing can advantageously be customized and, indeed, it is preferable if a sheet-fed printer is employed. Other customized printing can be performed on loot bags, puppets and noisemakers.

The arrangement 10 includes a moving silicone sealing belt 12 trained about a pair of belt rollers 14, 16 both mounted on a stationary frame 18. A carrier roll 20 supplies a support carrier 22 in a continuous web form. The carrier 22 is constituted of a shape-retaining material such as paper, preferably 24 pounds weight or heavier, or plastic, and is relatively stiff, but still able to be fed through a sheet-fed printer as described below. The carrier 22 adheres to the belt 12 and may have a gloss coating on its surface facing the belt to improve its adhesion thereto.

The arrangement 10 further includes a lower film roll 24 for supplying a lower film 26 in continuous web form, as well as an upper film roll 28 for supplying an upper film 30 in continuous web form. Each film 26, 30 is a laminate of thin gauge and includes a non-elastomeric polymer, such as nylon and/or polyethylene, having a continuous metallic coating, such as aluminum. Such laminated film is known as “foil” in the balloon art and generally has a thickness which depends on the density and malleability of the metal, typically 0.8 to about 2.4 mils, and is stretchable when nylon is used. Other polymer films and other metals may be utilized. Also, non-metallized metallized nylon, EVOH, polyesters and even paper with a heat-sealable inner coat may be used. It is conventional to extrude the laminate films. It is preferable for each film 26, 30, or at least one of them, to include a heat-set adhesive or a coating, such as polyethylene, that promotes subsequent heat sealing. The heat-set adhesives or polyethylene coatings face each other.

The upper film 30 is identical to the lower film 26, except that it is desirable to pre-coat the upper film 30 with an ink absorbing flood coating for providing a contrast background for the ink to be applied thereon, and an ink-absorbent top coating, known in the trade as a lacquer, for enabling the ink to permanently dry thereon and to resist smearing. Suitable lacquers for this purpose are available from Microseal Industries Inc. of Paterson, New Jersey and from Tekra Advanced Technologies Group of New Berlin, Wis.

The upper film 30, the lower film 26 and the carrier 22 are conveyed under tension to a nip roller 32 which presses the upper film 30 onto the lower film 26 and, in turn, onto the carrier 22 and the belt 12. The pressed-together assembly passes through a nip formed by rollers 32, 14 and is then passed through a heat sealing workstation 34, a die cutting workstation 36, a scrap removal workstation 38, and a sheeting workstation 40.

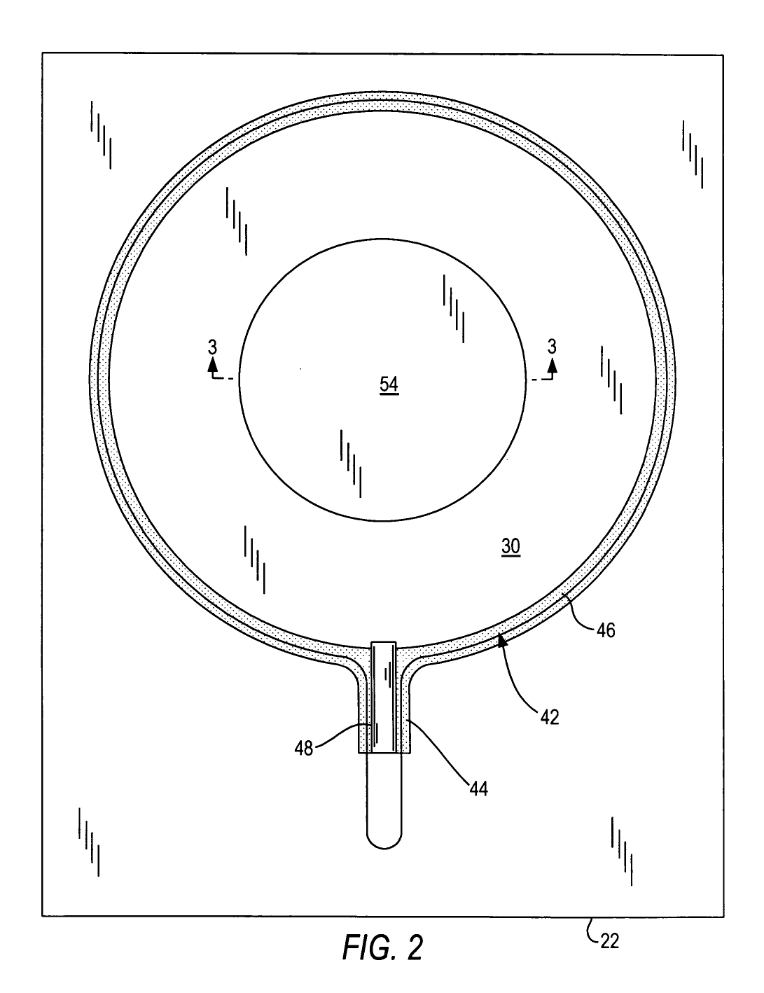

Referring now to FIG. 2, a carrier 22 cut into a rectangular sheet by the sheeting workstation 40 is depicted. The heat sealing workstation 34 is operative for sealing overlapping portions of the films 30, 26 together and, as shown by hatching, these sealed portions are identified by the reference numeral 42. The heat sealed portions 42 are generally circular, except at an inlet region 44 which is formed as an elongated inlet or nozzle.

At the die cutting workstation 36, an outline 46 of a balloon is cut. The outline 46 is closed and extends through both films, but does not extend all the way through the carrier. The cut may be clean or jagged. The cut is preferably performed within the sealed portions 42 and also exteriorly of the inlet. The cut could also be performed at the outer edge of the sealed portions 42, or exteriorly thereof. The heat sealing and the die cutting workstations can be combined into a single workstation. A Teflon™ impregnated, fiberglass, fabric belt 35 is trained about a set of rollers and passes underneath the heat sealing and die cutting heads of the workstations 34, 36. The fabric belt 35 prevents any heated film from adhering or melting on the sealing and cutting heads.

During the heat sealing and cutting operations, the films 30, 26 remain secured flat over their entire mutually facing surface contact area, as well as against the planar carrier 22 and are affirmatively retained in place by either static friction or by a repositionable adhesive placed between the films and/or between the lower film and the carrier. A heat-activated coating could also be applied to the underside of the lower film. The retention of the films ensures proper registry of the assembly at the workstations. Optical sensors (not illustrated) detect registry marks preprinted on the films to further insure registry at the workstations.

The resulting assembly is conveyed to the scrap removal workstation 38 where the excess material of the films from the cut outline 46 to the edges of the carrier 22 are delaminated.

The resulting balloon assembly is next conveyed to the sheeting station 40 where the webs in continuous or roll form are cut into the desired length sheets, for example, 8½″×11″ or 8½″×14″ or any desired size, especially those that can be loaded in and fed through a conventional printer.

In accordance with the invention, the position of the outline 46 is thus very accurately known relative to, and registered with, the outer peripheral edges of the rectangular carrier 22. For wide format printers, it is especially desirable not to perform a sheeting operation, but instead, to supply the balloon assemblies in roll form.

A heat-set adhesive or polyethylene coating is also preferably applied between the lower film and the carrier. The adhesive could be applied in advance on the lower film and/or on the carrier. Thus, when the sealing of the overlapping portions 42 is performed, the lower film is simultaneously heat tacked to the carrier by the same heat that is used for sealing. In a variant embodiment, the lower film can be adhered to the carrier in advance of sealing. In either event, the films, individually and collectively, are prevented from moving relative to each other and to the carrier.

The cutting of the films through the sealed and tacked overlapping portions prevents peripheral edges of the films from raising relative to the carrier. Foil balloons are currently heat sealed and heat die cut directly on the belt 12 without the aid of the support carrier discussed herein. The heat used during the sealing and die cutting operations causes the films to shrink somewhat in the vicinity of the heated areas. This shrinkage causes the outer peripheral cut edges of the films to curl and inhibits one from mounting a curled balloon on a carrier, or attempting to successfully print on a curled balloon. The tacking of the sealed overlapping portions eliminates any such shrinkage at the outer peripheral edges and such curling after cutting. In addition, the carrier affirmatively holds the films in place during cooling of the heated film portions, thereby minimizing the shrinkage and curling problems. Also, the use of a jagged cut helps prevent curling.

The scrap removal workstation 38 can be omitted. Indeed, the scrap films created after cutting the films may be left in place, or heat sealed to the carrier and remain part of the assembly sent to the sheeting station 40.

As also shown in FIG. 2, in the case of an inflatable, a valve 48 may be inserted between the upper and lower films in the inlet 44. Preferably, the valve 48 is a one-way, generally planar valve that prevents gas introduced into the inflated balloon from escaping from the inlet.

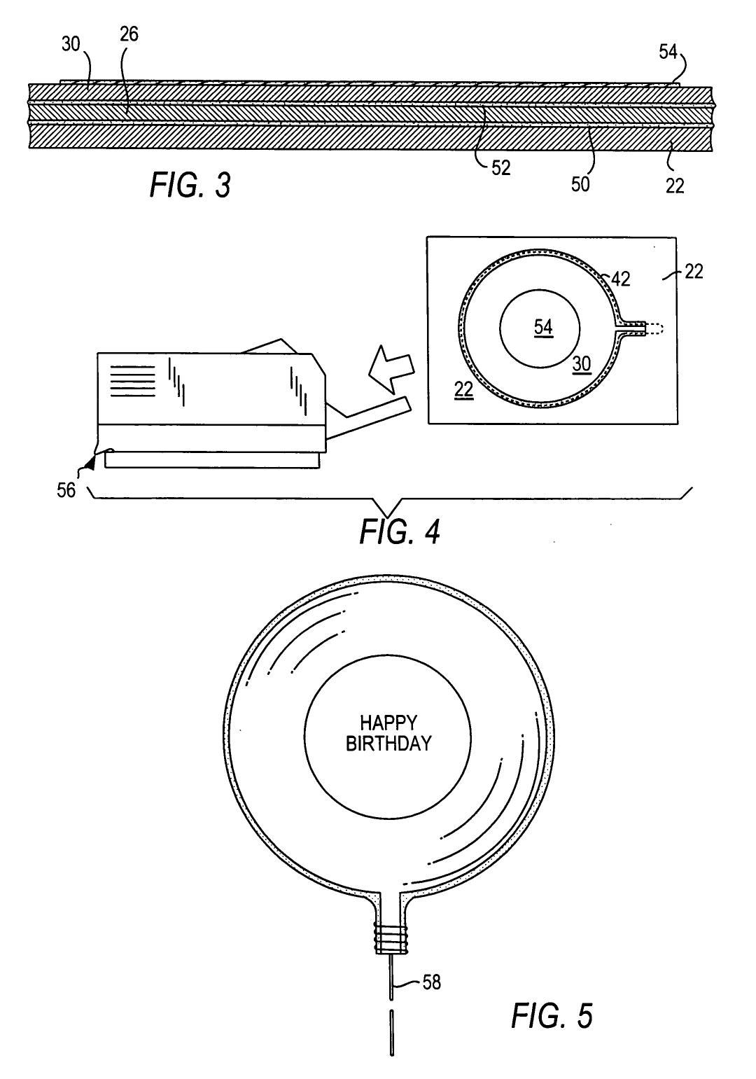

FIG. 3 is an enlarged cross-section in which the generally planar, laminated, wrinkle-free nature of the assembly is depicted. Also shown is the heat-set adhesive 50 between the lower film 26 and the carrier 22, and an optional repositionable adhesive 52 between the films 30, 26. The ink flood coating 54 on which printing is to be performed is also depicted. The coating 54 may be provided on the entire or part of the outer surface of the upper film.

The balloon assembly is now ready to have a customized design printed thereon. In some applications, at least a part of the design may be preprinted. Typically, a user creates or captures an image including graphics and/or text on a computer, and instructs the computer to print the image on a connected printer 56, either a front-feed, or a rear-feed, in which one of the balloon assemblies is about to be loaded, as shown in FIG. 4. During passage through the printer, the balloon assembly effectively travels as a single sheet due to the surface area adhesion between the films, the surface area adhesion between the lower film and the carrier, and the stiffness of the carrier which imparts its rigidity to the films which are flimsy and stretchable in comparison.

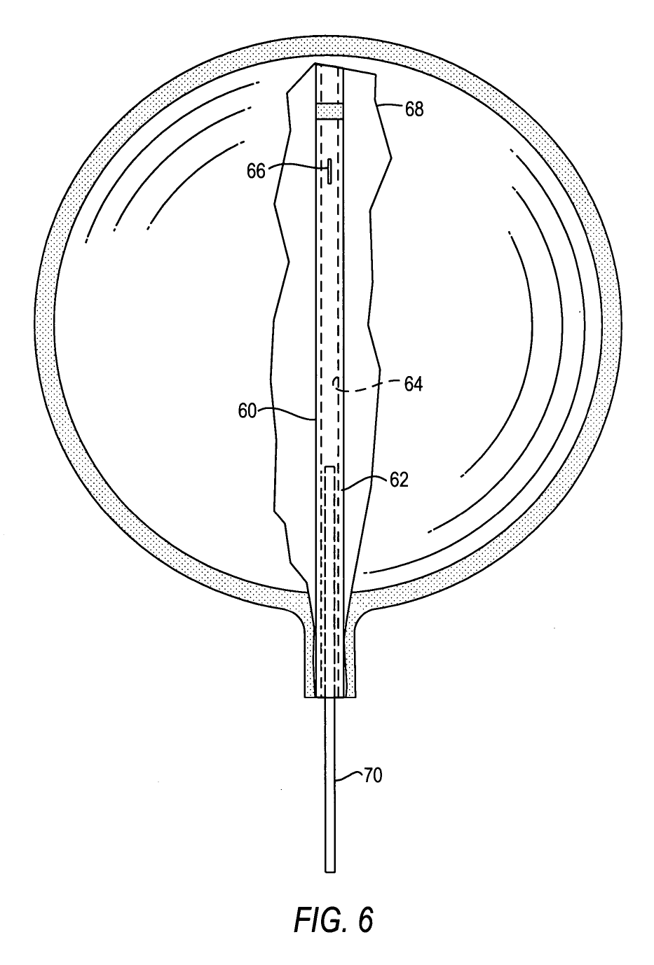

Once the image has been printed on the flood coating 54 of the upper film 30, the films constituting a balloon are peeled away from the carrier. The adhesive bond between the lower film and the carrier is easily broken, especially if a repositionable adhesive is used which readily enables such separation. The carrier is then discarded. The balloon is inflated by admitting gas into the inlet 44. A straw is often inserted between overlying flaps of the inlet 44 to enable the user to inflate the balloon by exhaling into the straw. Any adhesive bond between the films is also easily broken by the admitted gas because the repositionable adhesive, if used, readily enables such separation between the films. After inflation, the straw is removed, and the inlet 44 is sealed, for example, with a heat sealer. The inflated balloon could, if desired, be tied to a stick 58, as shown in FIG. 5.

One key aspect of this invention, as noted above, is the forming of the balloon itself directly on the carrier, and keeping the balloon films fixed on the carrier during subsequent manufacturing operations, especially printing. Another key aspect is the broad affirmative adhesion not only between the upper and lower films at all times during the heat sealing, cutting and especially during the printing, operation, but also the affirmative adhesion between the lower film and the carrier. Preferably, the adhesive is applied on the carrier, and not on the lower film. The upper film is affirmatively prevented from stretching and moving during these operations, and especially during printing as the balloon assembly is engaged by the printer rollers and conveyed through the printer. The carrier effectively stiffens the films. The stiffness of the carrier imparts its strength to maintain the shape and position of the more flexible films. No wrinkling of the upper film occurs. No mis-feeds or roller wraparounds occur. No smearing of ink on high points of loose upper film occurs. No voids occur at low points of loose upper film. No mis-registration occurs, because the carrier enables accurate image registration. The result is a clean, distinct, unblemished image free of smears and smudges, and which is printed exactly in the correctly registered area on the upper film. Despite any presence of an adhesive coating between the films, the adhesive bond is easily overcome during inflation. The inside surfaces of the films delaminate when air is forced into the interior of the balloon.

Variants of this invention include the filling of the balloon with a gas other than exhaled air, for example, helium; the shaping of the balloon to be other than one having a circular outline; the sizing of the balloon to be on the order of 18″ or more in diameter for printing on wide format printers; the printing of the design at a site other than at a user's home, for example, at a retail site; the use of a film that does not require a flood coating; the sealing and the cutting of the films using a laser; the forming of multiple sealed film assemblies on a single carrier; and the printing of the customed design can occur prior to the sealing being performed.

The repositionable adhesive is an adhesive such as the Repositionable Adhesive No. 380 available from CAMIE-Campbell Inc. of St. Louis, Mo. The adhesive could also be a microsphere type. Means other than a repositionable adhesive, for example, electrostatic attraction forces could be used. For example, the inner facing surfaces of the films could be coated with layers that have a static cling characteristic. The increased surface tension between the films acts to affirmatively hold the films together in surface area contact. Similarly, the lower surface of the lower film and the upper surface of the substrate could be coated with layers that have a static cling characteristic to hold them securely together.

It is preferred to use the self-sealing valve 48 at the balloon inlet 44. The valve 48 can be mounted on the lower film and held in position after the upper film is heat sealed to the lower film. The valve helps control the flow of the gas and prevents escape of the gas.

In a variant, the carrier can be punched or perforated around a removable section. After removal of the section, a window is formed and exposes a region of the lower film. The exposed region is thus available to be printed upon if the balloon assembly is passed through the printer. In this way, both sides of the balloon will have a customized design. Both sides may be simultaneously printed if the printer supports double-sided printing. Otherwise, two passes through the printer are required. If printing on the lower film is contemplated, then the lower film is also coated with the ink absorbing lacquer mentioned above. The window also serves to relieve stress in case any waves or ripples tend to form in the balloon films, especially on larger sizes and a few days after the balloon is formed on the carrier. Instead of a window, one or more slits can be formed in a central region of the carrier to affirmatively resist the formation of waves or ripples in the films.

It is contemplated that the balloon assemblies will be sold individually or in stacks to consumers. The consumer need only perform the customized printing operation. The printed uninflated assembly could be sent to a recipient as is, thereby serving as an inflatable greeting card. The consumer could be instructed to peel and inflate the balloon. Of course, the consumer could perform the inflation operation and, for example, attach the inflated balloon to a gift for an attractively wrapped present. The consumer could even be instructed to cut the balloon into a desired shape or outline. Other uses include floral arrangements, cakes and centerpieces.

Still another contemplated application is to supply balloon assemblies in roll form to a commercial printer. These balloon assemblies would comprise the upper and lower films laminated to a substrate as described above, and the films would be heat sealed together, and die cut. These balloon assemblies would be delivered to a commercial printer who would perform a printing operation, such as offset printing, or rotogravure printing, and then perform a sheeting operation. The commercial printer would then supply the resulting balloon assemblies in sheet form to its customers, either retail stores for resale to consumers, or directly to the consumers.

As previously noted, the heat-set adhesive between the lower film and the carrier, when activated by heat, causes the sealed film assembly to be held on the carrier only at the overlapping sealed portions, that is, those areas exposed to heat. This insures that the film assembly can be readily detached from the carrier. Also, it insures that the entire outer surface of the lower film, which is exposed after removal from the carrier, will not be tacky. Such a tacky outer surface is undesirable in the finished balloon product.

FIG. 6 depicts a balloon removed from the carrier, and prior to being inflated. The balloon of FIG. 6 is analogous to that being formed in FIG. 2, except for a modified valve.

Balloon valves used in foil balloons today are typically constructed from two strips of 1.5 mil low density polyethylene (LDPE) film heat sealed together along two parallel lines to form a channel (½″ to ¼″ width) which allows air or helium to be forced through the channel into the balloon. The end of the valve inside the balloon is unattached, and the gas pressures created inside the balloon during the inflation process, act to press the two layers of film strips together, prohibiting any gases from exiting through the channel. A typical valve is 6″-7″ in length.

Most foil balloons that are filled with helium are tethered by tying a ribbon or string to the neck of the balloon. Air filled balloons are most often attached to a conical plastic device by wrapping and threading the neck of the balloon to it. The conical device (“the cone”) has a molded tubular chamber into which a plastic straw/stick is inserted to form a “balloon stick”. This acts as a handle/display system for the inflated balloon. The cone adds to the overall cost of the product and is difficult and time consuming to manually attach. That is why most commercially sold air-filled balloons utilize a machine to attach the balloon to the cone.

There is a need for a new system to attach air filled balloons to balloon sticks. The new system simplifies the attachment process at a reduced cost. The gas pressure within the inflated balloon will press the valve film against the inserted balloon stick, which will keep the balloon from slipping off the stick. The new valve vertically extends from the bottom neck portion of the balloon to the top seal of the balloon. The valve would be heat-sealed into the neck, heat-tacked approximately one inch below the top seal and heat-sealed into the top perimeter of the balloon.

The new valve would have the following features: Two strips of LDPE heat sealed together with two parallel seals 60, 62 approximately ½″ apart forming an inflation channel 64. A registered slit 66 is cut into the top section valve just prior to the valve insertion into the balloon. This slit will allow the gas forced into the inflation channel to enter the balloon, but will not allow gases to escape when the internal gas pressure is sufficient to press the film layers together. This is required since the top end of the valve has been sealed closed. A critical step in achieving the proper balloon support from the valve channel is to heat tack a top section 68 of the valve to the lower film 26 approximately one inch below the twelve o'clock position of the outer perimeter balloon seal just prior to the balloon formation.

The support/attachment system will rely on a balloon stick 70 inserted into the valve channel 64. When the balloon is inflated, the effective diameter of the balloon has been reduced and therefore, the valve which extends from the top to bottom of the balloon, now has slack in it. The reason that the valve is tacked to the bottom film approximately one inch below the top of the balloon is to remove most of the slack that develops in the valve upon the balloon inflation. By removing this slack in the valve, after the balloon stick that has been inserted, the amount of forward and back movement that is allowed by the valve has been reduced, and the balloon will stand erect on the stick.

It will be understood that each of the elements described above, or two or more together, also may find a useful application in other types of constructions differing from the types described above.

While the invention has been illustrated and described as foil balloons customized with unblemished designs and their manufacture, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the present invention.

What is claimed as new and desired to be protected by Letters Patent is set forth in the appended claims.

I claim:

1. A method of manufacturing an object, comprising the steps of:
a) forming a support carrier of a shape-retaining material;
b) positioning a lower film of a flexible material more flexible than the material of the carrier, on and in overlapping relationship with the carrier;
c) positioning an upper film of a flexible material more flexible than the material of the carrier, on and in overlapping relationship with the lower film; and
d) sealing overlapping portions of the films together to form a sealed film assembly while the films are positioned on the carrier.

2. The method of claim 1; and the step of feeding the support carrier from a carrier roll through a sealing station at which the sealing is performed; and wherein each positioning step is performed by feeding the lower and upper films from respective film rolls through the sealing station.

3. The method of claim 1; and the steps of coating the lower and upper films with fusible coatings; and wherein the positioning steps are performed by feeding the lower and upper films with the fusible coatings facing each other.

4. The method of claim 1; and the step of conveying the support carrier on a silicone sealing belt through the sealing station.

5. The method of claim 1; and the step of adhering the lower film to the carrier simultaneously with performing the sealing step to maintain a correct positional relationship between the sealed film assembly and the carrier during manufacture.

6. The method of claim 1; and the step of laminating the lower film to the carrier prior to performing the sealing step.

7. The method of claim 1; and the step of cutting the films while the films are positioned on the carrier.

8. The method of claim 7, wherein the cutting step is performed simultaneously with the sealing step.

9. The method of claim 7, wherein the cutting step is performed subsequently to the sealing step.

10. The method of claim 7, wherein the overlapping portions are sealed boundary areas extending at least partly along a periphery of the object to be manufactured, and wherein the cutting step is performed at least partly within the boundary areas.

11. The method of claim 10, wherein the carrier has peripheral edges, and wherein the boundary areas are cut along a cutting line located at a spacing from the peripheral edges; and the step of removing the lower and upper films from the spacing.

12. The method of claim 10, wherein the carrier has peripheral edges, and wherein the boundary areas are cut along a cutting line located at a spacing from the peripheral edges; and the step of leaving the lower and upper films in the spacing.

13. The method of claim 2; and the step of cutting the carrier subsequently to the sealing step to form a sheet on which the sealed film assembly is supported.

14. The method of claim 1; and the step of printing on the sealed film assembly in registration with the carrier.

15. The method of claim 1; and the step of inserting an inflation valve in the sealed film assembly.

16. The method of claim 1, wherein the lower and upper films overlap and contact each other over a surface area; and the step of adhering the lower and upper films together over the entire surface area of contact.

17. An arrangement for manufacturing an object, comprising:
a) means for supplying a support carrier of a shape-retaining material;
b) means for positioning a lower film of a flexible material more flexible than the material of the carrier, on and in overlapping relationship with the carrier;
c) means for positioning an upper film of a flexible material more flexible than the material of the carrier, on and in overlapping relationship with the lower film; and
d) means for sealing overlapping portions of the films together to form a sealed film assembly while the films are positioned on the carrier.

18. The arrangement of claim 17; and means for adhering the lower film to the carrier simultaneously with operation of the sealing means to maintain a correct positional relationship between the sealed film assembly and the carrier during manufacture.

19. The arrangement of claim 17; and means for cutting the films while the films are positioned on the carrier.

20. The arrangement of claim 17; and means for printing on the sealed film assembly in registration with the carrier.

21. A sealed film assembly, comprising:
a) a support carrier of a shape-retaining material;
b) a lower film of a flexible material more flexible than the material of the carrier, on and in overlapping relationship with the carrier;
c) an upper film of a flexible material more flexible than the material of the carrier, on and in overlapping relationship with the lower film; and
d) overlapping portions of the films being sealed together to form the sealed film assembly while the films are positioned on the carrier.

22. An inflatable film assembly, comprising:
a) a pair of overlapping, flexible films having portions sealed together to bound an interior;
b) an inlet on the films for admitting gas into the interior; and
c) a valve extending between the inlet and the sealed portions, the valve having an intermediate portion adhered to one of the films.
